(19) United States
(12) Patent Application Publication
(10) Pub. No.: US 2019/0282429 A1
(43) Pub. Date: Sep. 19, 2019

(54) POSTURE RESTORING ASSEMBLY FOR WEARABLE ASSISTIVE DEVICE

(71) Applicant: LG ELECTRONICS INC., Seoul (KR)

(72) Inventors: Jung Kyu SON, Seoul (KR); Bohyun NAM, Seoul (KR); Kyu Tae PARK, Seoul (KR); Seonil YU, Seoul (KR); Wonjun LEE, Seoul (KR)

(21) Appl. No.: 16/353,843

(22) Filed: Mar. 14, 2019

Related U.S. Application Data
(60) Provisional application No. 62/730,399, filed on Sep. 12, 2018.
(60) Provisional application No. 62/730,400, filed on Sep. 12, 2018.
(60) Provisional application No. 62/730,412, filed on Sep. 12, 2018.
(60) Provisional application No. 62/730,420, filed on Sep. 12, 2018.

(30) Foreign Application Priority Data
Mar. 15, 2018 (KR) 10-2018-0030470

(51) Int. Cl. A61H 3/00

(52) U.S. Cl. CPC A61H 3/00; A61H 2201/1626; A61H 2201/165; A61H 2201/1657; A61H 2003/007

(57) ABSTRACT

An exoskeleton may include a pair of actuated limbs rotatably arranged at sides of a lumbar/back frame. A posture restoring assembly may connect the sides of the lumbar/back frame and an upper end of the actuated limbs and return the actuated limbs to an initial or resting position thereof via an elastic or restoring force.

### CROSS-REFERENCE TO RELATED APPLICATION(S)

This application claims priority under 35 U.S.C. to § 119 to U.S. Provisional Patent Application Nos. 62/730,399, 62/730,400, 62/730,412, and 62/730,420, all filed on Sep. 12, 2018, and also priority to and the benefit of Korean Patent Application No. 10-2018-0030470, filed on Mar. 15, 2018, whose entire disclosures are incorporated herein by reference.

### BACKGROUND

### 1. Field

The present invention relates to assistive and/or rehabilitative technology.

### 2. Background

In assistive and/or rehabilitative technology, a wearable assistive device such as a wearable robot or robotic exoskeleton may assist and/or augment a movement or strength of a user by providing an assistive force at various joints. The wearable assistive device may have a multi-joint skeletal structure to assist a muscular power or strength of the user when the user dons or wears the wearable assistive device. The assistive force may be provided by a driving apparatus such as a motor. An example of the wearable assistive device is disclosed in Korean Patent Application Publication No. 10-2013-0045777, published on May 6, 2013.

FIG. 1 is a perspective view of a conventional wearable robot according to the related art. Referring to FIG. 1, the wearable robot may be worn on a lower body of person to assist a muscular power or strength of a leg so that the user can comfortably and continuously walk.

As shown in FIG. 1, the wearable robot may include a waist frame 11, a thigh support 12, a shin support 14, and a foot link 16. A pair of leg assemblies may be arranged at both sides of the waist frame 11, respectively. Each of the leg assemblies may have the thigh support 12, the shin support 14, and the foot link 16.

A hip actuator 13 may be installed between the thigh support 12 and the waist frame 11 to assist a movement of a thigh of a user. A knee actuator 15 may be installed between the shin support 14 and the thigh support 12 to assist a movement of the shin.

In some cases, a pair of leg drives including the hip actuator 13 and the knee actuator 15 may assist a walking movement of a user. The hip actuator 13 and the knee actuator 15 may only generate an assistive force when the user walks. When the assistive force is not generated, the thigh support 12 and the shin support 14 may not return to an original posture of the wearable assistive device. Accordingly, when the wearable assistive device is not used, parts of the leg assembly, such as the thigh support 12 and the shin support 14, may not be returned to an initial or resting posture.

When the wearable robot is supported on a supporter and stored in an unbalanced posture, the leg assembly may have an unbalanced or uneven weight, which may cause instability and damage. In addition, the wearable robot may be unstable when the user continues to wear the wearable robot, as there may be no restoring force that returns the leg assembly to the original position.

### BRIEF DESCRIPTION OF THE DRAWINGS

Embodiments will be described in detail with reference to the following drawings in which like reference numerals refer to like elements, and wherein:

FIG. 1 is a perspective view of an exoskeleton;

FIG. 2 is a perspective view of an exoskeleton according to an embodiment;

FIG. 3 is a side view of the exoskeleton according to FIG. 2;

FIG. 4 is a front view of an exoskeleton according to an embodiment;

FIG. 5 is a perspective view of a configuration of a posture restoring unit according to an embodiment;

FIG. 6 shows an arranged state of a spring according to an embodiment;

FIGS. 7 and 8 show an operation in which a pair of actuated limbs extends outward according to an embodiment;

FIGS. 9 and 10 show a state where an actuated limb is returned to an initial position thereof by a posture restoring assembly according to an embodiment;

FIG. 11 shows another example of connecting a spring according to an embodiment;

FIG. 12 shows an example in which a position where an end of a spring is connected to a fixing member may be changed according to an embodiment;

FIG. 13 shows an example in which a plurality of springs are provided according to an embodiment; and

FIG. 14 shows another example in which a spring is fixed to a fixing member according to an embodiment.

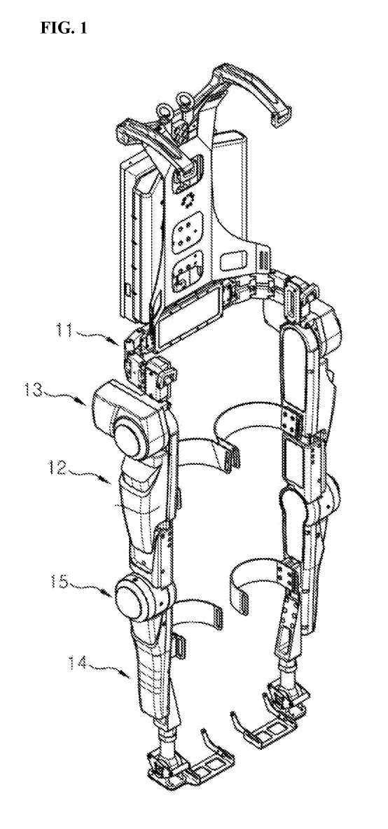

### DETAILED DESCRIPTION

The foregoing objects, features and advantages will be described later in detail with reference to the accompanying drawings, so that those skilled in the art will easily carry out the technical features of the present disclosure. In the description of the present disclosure, a detailed description thereof will be omitted when the specific description with related known arts may unnecessarily obscure the gist of the present disclosure. Hereinafter, the embodiments of the present disclosure will be described in detail with reference to the accompanying drawings. In the drawings, like reference numerals refer to the same or similar components.

A wearable assistive device such as a wearable robot, e.g., exoskeleton, may be worn on a body and may assist and/or augment a movement or strength of a user. Hereinafter, an exoskeleton worn on a lower body for the user will be briefly described as an example of a structure of an exoskeleton (hereinafter, the user is defined as a person who wears an exoskeleton). However, embodiments disclosed herein are not limited to a lower body exoskeleton structure, and an exoskeleton may be configured to support the whole body of a user, an upper body of the user, or a center or core of the user.

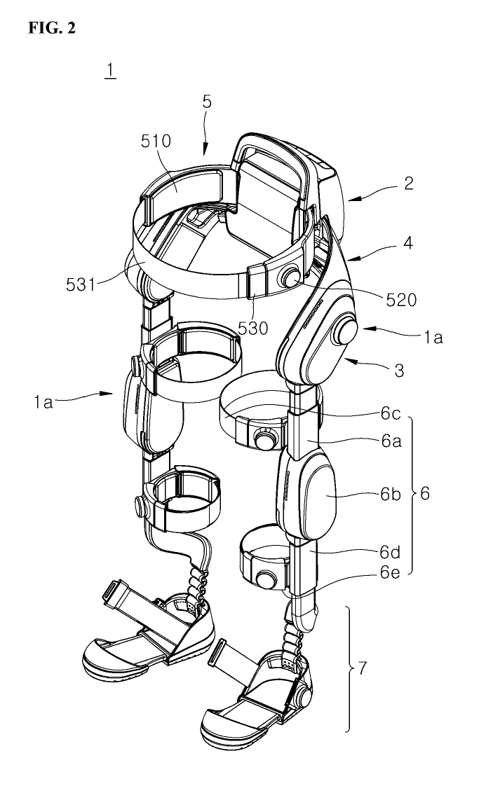

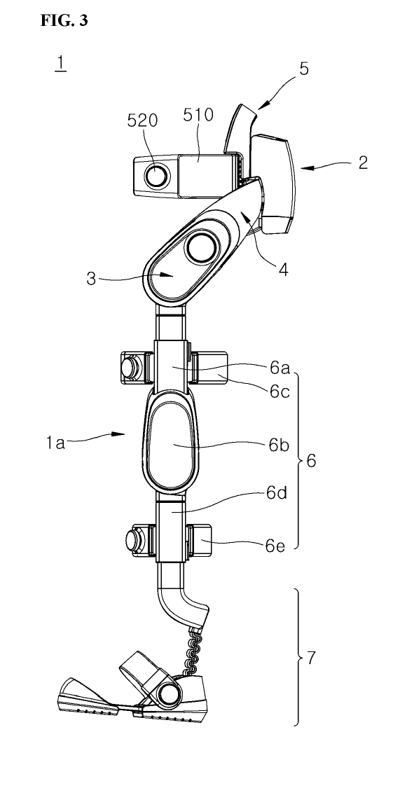

First, according to an embodiment, an overall configuration of the exoskeleton having a hip or waist support for an exoskeleton will be described. As shown in FIGS. 2 and 3, an exoskeleton 1 may assist a muscular power or strength of a lower body of a user when the user moves (e.g., walks, bends, or lifts) while wearing the exoskeleton 1 on a lower body.

According to the present disclosure, the exoskeleton 1 may include a lumbar/back frame 2 housing a main controller 2 for function control, an actuated hip joint 3, a main frame 4 secured to a pelvis, e.g., ilium, and a subframe or waist/pelvic frame 5 secured to a pelvis or waist, a leg or a leg assembly secured to a leg of the user 6, and a foot support 7 secured to a foot or a shoe. The main frame 4 may house a subcontroller. Details of the main controller and the subcontroller are found in U.S. application Ser. No. 16/274,584 (Attorney Docket No. DAE-0073) filed on Feb. 13, 2019 and Ser. No. 16/274,613 (Attorney Docket No. DAE-0074) filed on Feb. 13, 2019, the entire contents of which are incorporated herein by reference. The lumbar/back frame 2 may be provided on the main frame 4 and may be secured at a rear of the user. The lumbar/back frame 2 may adjust a width of the main frame 4 depending on a body or waist size. In addition, the lumbar/back frame 2 may include a battery pack or power supply (not shown) that provides power or charge to operate the exoskeleton. The subframe 5 may be coupled to the lumbar/back frame 2.

The subframe 5 may support and be secured to the waist of the user via a belt that is adjustable in length in a one-touch or button-dial manner. As an example, the subframe 5 may have a first support 510 and a second support 520 having a knob or button dial. A belt or strap 531 may be withdrawn from the first support 510, and a buckle 530 of the belt 531 may be inserted into and fastened to the second support 520. A section of the belt or the subframe 5 that contacts the waist of the user may include a shock-absorbing material to improve comfort. Details of the subframe 5 are found in U.S. application Ser. No. 16/274,662 (Attorney Docket No. DAE-0076) filed on Feb. 13, 2019, Ser. No. 16/274,697 (Attorney Docket No. DAE-0077) filed on Feb. 13, 2019, and Ser. No. 16/352,940 (Attorney Docket No. DAE-0086) filed on Mar. 14, 2019, the entire contents of which are incorporated by reference herein.

The main frame 4 may support the lumbar/back frame 2 and may have a shape that extends from a first, i.e., left, side to a second, i.e., right, side of the pelvis or ilium. The main frame 4 may be substantially ‘U’-shaped, and the lumbar/back frame 2 may be coupled to a center or bent section of the U-shape of the main frame 4. The bent section of the main frame 4 may be provided at a rear of the user. First and second ends of the main frame 4 may extend downward along a pelvis, e.g., ilium, of the user toward the leg. The main frame 4 may thus have inclined portions at first and second sides, and the subcontroller may be provided at the inclined portion.

The subcontroller may adjust a strength or magnitude of an assistive force that assists muscular power of a user. The assistive force may be adjusted via the subcontroller in a rotary dial manner. The subcontroller and/or the main frame 4 may have an indicator that indicates a degree of a current assistive force applied. As an example, the indicator may be a lamp or light-emitting device (e.g., light-emitting diode). A driving means or actuator (e.g., electric, hydraulic, or pneumatic) to provide the assistive force may be provided at the actuated joint 3. The leg assembly 6 may be coupled to a lower portion of the actuated joint 3.

There may be two leg assemblies 6 to correspond to the user's pair of legs, and each leg assembly 6 may be secured to a corresponding leg of the user. Each leg assembly 6 may include an upper leg frame 6a secured to a thigh via a leg belt 6c, a lower leg frame 6d secured to a calf of via a leg belt 6d, an actuated joint 6b provided between the upper leg frame 6a and the lower leg frame 6d, and a leg drive provided at the actuated joint 6b to provide an assistive force. The leg belts 6c and 6d may be adjustable via a one-touch dial method. Details of the leg belts 6c and 6d are found in U.S. application Ser. No. 16/282,409 (Attorney Docket No. DAE-0084) filed on Feb. 22, 2019 and Ser. No. 16/352,920 (Attorney Docket No. DAE-0085) filed on Mar. 14, 2019, the entire contents of which are incorporated by reference herein.

The upper leg frame 6a, the lower leg frame 6d, and the actuated joint 6b may be arranged along a side of the legs so as not to interfere with a bending motion of the user's joints during movement (e.g., walking, lifting, or bending). The upper leg frame 6a and the lower leg frame 6d may rotate in directions corresponding to movements of the user's hip and knee joints about the actuated hip joint 3 and the actuated joint 6b. The upper leg frame 6a may rotate about the actuated hip joint 3 provided between the main frame 4 and the upper leg frame 6a, and the lower leg frame 6d may rotate about the actuated joint 6b provided between the upper leg frame 6a and the lower leg frame 6d. The upper and lower leg frames 6a and 6d may rotate in a sagittal plane of the user such that the upper and lower leg frames 6a and 6d extend forward and backward from the user.

A rotation of the upper and lower leg frames 6a and 6d may be driven by motors and gear sets or actuators (e.g., hydraulic, electric, or pneumatic) provided at the actuated hip joint 3 and the actuated joint 6b. The actuated hip joint 3 and the actuated joint 6b may be replaced with other components other than a motor and gear set capable of generating appropriate assistive forces. The assistive forces may thus be forces of the motors or actuators driving a rotation of the upper and lower leg frames 6a and 6d. As the upper and lower leg frames 6a and 6d rotate, the user's thigh and calf may also rotate along with the upper and lower leg frames 6a and 6d. The assistive forces may thus assist the user's hip and knee joint movements.

An upper portion of the upper leg frame 6a may extend outward (i.e., to left and right sides) by a predetermined angle by a hip structure of a main frame 4. The user may thus freely move his or legs inward and outward (i.e., abduction and adduction) in a frontal plane of motion. Details of the hip structure of the main frame 4 are found in U.S. application Ser. No. 16/282,458 (Attorney Docket No. DAE-0075) filed on Feb. 22, 2019, the entire contents of which is incorporated by reference herein.

Further, the upper leg frame 6a and the lower leg frame 6d may have a multi-joint structure capable of adjusting an angle inward or outward to fit to an angled form of the two legs. In other words, the upper and lower leg frames 6a and 6d may be adjusted outward or inward such that the upper and lower leg frames 6a and 6d may conform to shapes of the user's thigh and calf and such that the leg assembly 6 may have a maximum contact with the user.

The foot support 7 may be coupled to a lower end of the lower leg frame 6d to supports a bare foot, socked foot, or shoe of the user. The foot support 7 may have an adjustable length at a portion where the shoes of the user are inserted. The foot support 7 may also have an adjustable tightness or width to secure a top of the shoes. Therefore, the foot support 7 may accommodate and secure to a variety of shoes, regardless of size or shape. Details of the foot support 7 are found in U.S. application Ser. No. 16/274,560 (Attorney Docket No. DAE-0072) filed on Feb. 13, 2019 and Ser. No. 16/274,798 (Attorney Docket No. DAE-0095) filed on Feb. 13, 2019, the entire contents of which are incorporated by reference herein.

The foot support 7 may be optional, and the exoskeleton A may be an upper body exoskeleton, lower body exoskeleton, or an exoskeleton configured to be supported on an entire body of a user. For example, the exoskeleton A may instead be an upper body exoskeleton, which may have a lumbar/back support 2 housing a main controller, a main frame 4, a subframe 5, a limb assembly 6 extending upward from the main frame 4, and at least one actuated joint 3 or 6b. An exoskeleton A may also fit onto a complete or entire body of the user to accommodate both leg and arm limbs.

Although not shown, embodiments disclosed herein may not be limited to a complete lower body exoskeleton based on an intended use of the exoskeleton. For example, the actuated joint 6b, the lower leg frame 6d, the leg belt 6e, and the foot support 7 may be omitted. Thus, an exoskeleton A may provide assistance to the user at the actuated hip joint 3, and may include a main frame 4, a lumbar/back frame 2, and a leg assembly 6 that includes only an upper leg frame 6a that secures to a thigh of the user via a leg belt 6c. Such an upper leg exoskeleton A may have a hip structure substantially the same as or similar variations to the hip structure of the main frame 4 described in detail herein.

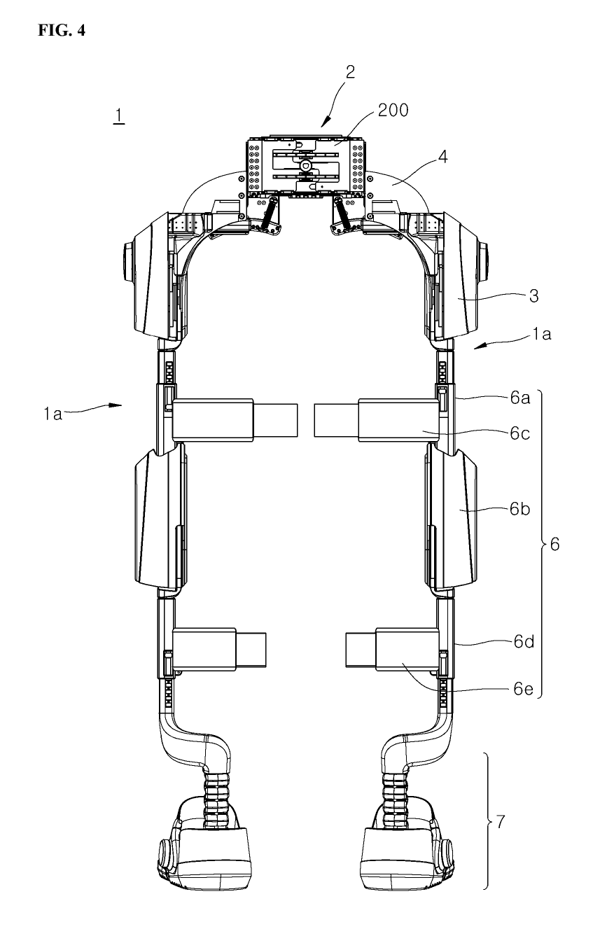

Referring to FIG. 4, a posture restoring assembly or device may be installed in an exoskeleton 1. As previously described, the exoskeleton 1 may have a lumbar/back frame 2. The lumbar/back frame 2 may be connected to a subframe 5. The subframe 5 may be bent or curved so as to surround the waist or pelvis.

The lumbar/back frame 2 may have a main body 200 on which a main printed circuit board (PCB) (not shown) is installed. A pair of connectors or connector plates 210 may be provided at a lower end or bottom of the main body 200 to couple to a pair of ends or extensions of the main frame 4, respectively. The connectors 210 may also be referred to as plates 210.

Each connector 210 may have a plate shape. The connectors 210 may be spaced apart from each other by a predetermined distance on the lower end or bottom of the main body 200. The connector 210 may have an upper end coupled to the bottom of the main body 200, while a lower end may extend a predetermined length away from the main body 200.

A pair of actuated limbs or joint structures 1a may be arranged at first and second, i.e., left and right, sides of the main body 200. The pair of actuated limbs 1a may be symmetrical to each other. Each actuated limb 1a may include a side or extension of the main frame 4, a leg assembly 6, and a foot support 7. The configurations of the leg assembly 6 and the foot support 7 may be the same as the above-described configuration, and the description thereof will be omitted.

The main frame 4 may be installed to have an actuated joint 3 that provides an assistive force to a hip of the user. The main frame 4 may be bent so as to surround the hips or pelvis, e.g., ilium, of the user. The main frame 4 may constitute separate extensions corresponding to first and second, i.e., left and right, sides of the hip or pelvis. As described above, the main frame 4 may be rotatably connected to the lower ends of the main body 200 at first and second sides of the main body 200.

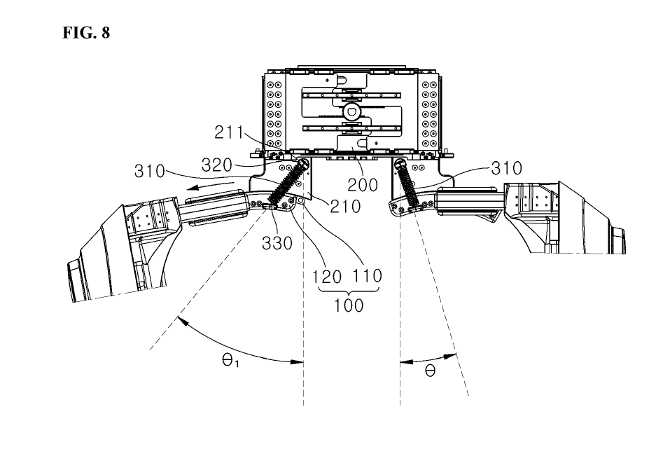

A rotation or movement of an entire actuated limb 1a about the back/lumbar frame 2 can be guided by a guide 100. The guide 100 may include a rail member 110 (FIG. 8) and a movable member or a frame 120. The rail member 110 may be installed at the lower end of the connectors 210 extending from the bottom of the main body 200.

The rail member 110 may be shaped to have an upward convex curvature to provide a movement path along the curvature. As an example, the movement path may be a groove or recess. Alternatively, the movement path may be a rail or bar. The movement path may extend in a left-right direction and curve upwards, such that a rotation axis of the movement path may be in a y-axis direction (FIG. 8).

The movable member 120 may be installed at or coupled to an upper end of the actuated limb 1a. As an example, the movable member 120 may couple an extension of the main frame 4 to protrude from the extension of the main frame 4. The movable member 120 may be coupled to the rail member 110 by a rail method, and may be moved along the movement path of the rail member 110. As an example, the movable member 120 may include a bar or rail that is inserted into a groove of the rail member 110, and the movable member 120 may slide along the rail member 110. As an alternative example, the movable member 120 may include a groove that fits onto a bar or rail of the rail member 110, and the movable member 120 may slide along the rail member 110. Embodiments disclosed herein are not limited to the above-described configurations, and the movable member 120 and the rail member 110 may be configured such that the movable member 120 and the rail member 110 are slidably coupled.

Thus, each of the actuated limbs 1a may be rotated or pivoted leftward and rightward in a frontal plane of motion around the y-axis as the movable member 120 moves along the rail member 110. The pivoting of the actuated limbs 1a may allow the actuated limbs 1a to be opened outward and closed inward (i.e., abduction and adduction).

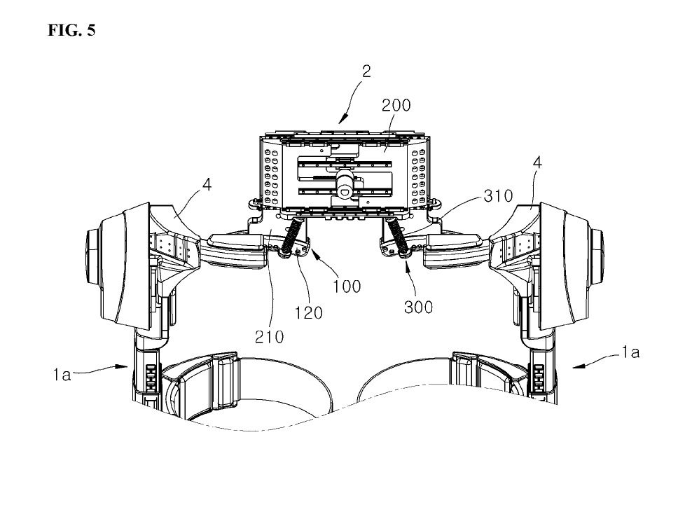

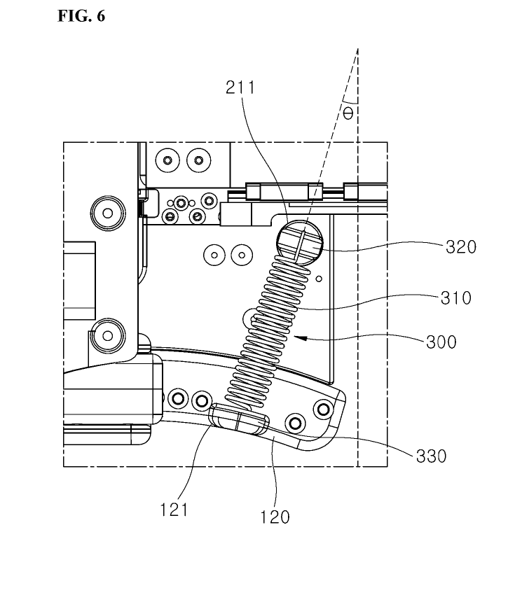

The exoskeleton 1 may further include a posture restoring device or assembly 300. Referring to FIGS. 5 and 6, the posture restoring assembly 300 may provide an elastic restoring force that elastically connects extensions or sides of the main frame 4 and the bottom of the main body 200. The posture restoring assembly 300 may thus return or restore the actuated limbs 1a to an initial or original position. The initial position may also be referred to as a resting, relaxed, or neutral position.

The posture restoring assembly 300 may include an elastic object or a spring 310. The spring 310 may have a predetermined elastic force or restoring force. The spring 310 may be, for example, a coil spring or rubber band. However, embodiments disclosed are not limited to the above-described springs, and the spring 310 may be any elastic object that has an elastic or restoring force. The spring 310 may also be referred to as an elastic member.

A pair of springs 310 may be provided and arranged at first and second sides of the bottom of the main body 200, respectively. Each spring 310 may have a first end, i.e., upper end, connected to the upper end of each connector 210, respectively. Alternatively, the upper end of the spring 310 may be connected to the bottom of the main body 200. The spring 310 may have a second end, i.e., lower end, connected to the movable member 120 at a predetermined position.

The spring 310 may have an initial posture corresponding to when the actuated limbs 1a are parallel to each other. At the initial posture, the lower end of the spring 310 may form an angle θ (FIG. 8), which may be an acute angle, with respect to an axis between the pair of actuated limbs (e.g., a vertical or z-axis). The spring 310 may be in a compressed state. Alternatively, the spring 310 may be in a neutral state. In another exemplary embodiment, the spring 310 may be in a slightly expanded state, but not maximally expanded.

Referring to FIG. 6a method of coupling and securing the spring 310 will be described. As previously described, the upper end of the spring 310 may be connected to the upper end of the connector 210, and the connector 210 may be formed at the lower end or bottom of the main body 200.

The second end of the spring 310 may be coupled to or formed with a fixing member 330, which may be configured to fit into a groove or recess 121 formed in the movable member 120 of the main frame 4. The groove 121 may be formed in a predetermined position in the movable member 120, and the fixing member 330 may be firmly fixed (e.g., pressed-fit or screwed) in the groove 121. As an example, the fixing member 330 may have a shape corresponding to a shape of the groove 121. The fixing member 330 may, as an example, have threads corresponding to threads of the groove 121, but embodiments disclosed herein are not limited to the described examples of the fixing member 330 and the groove 121.

The predetermined position where the groove 121 is formed may be a position where the spring 310 forms an acute angle with the groove 121. A rotation member 320 may be installed on or formed with the upper end of the spring 310. The rotation member 320 may be rotatably connected to a rotation groove or socket 211 formed in the connector 210. As an example, the rotation member 320 may have a shape, e.g., cylindrical bar or sphere, configured to rotate within the socket 211. The socket 211 may have a shape, e.g., hollow cylindrical recess or spherical cavity, configured to accommodate the rotation member 320. The socket 211 may alternatively be a hole that penetrates through the connector 210.

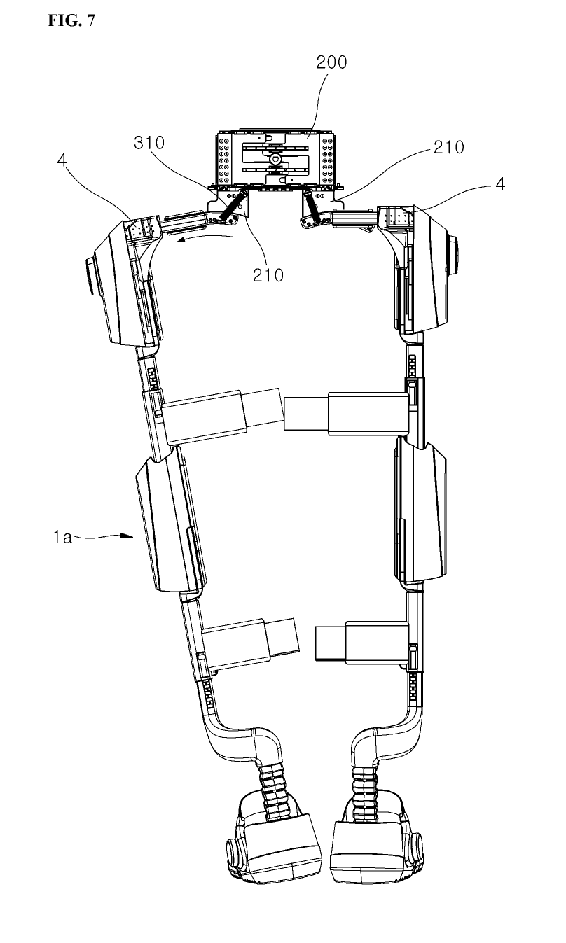

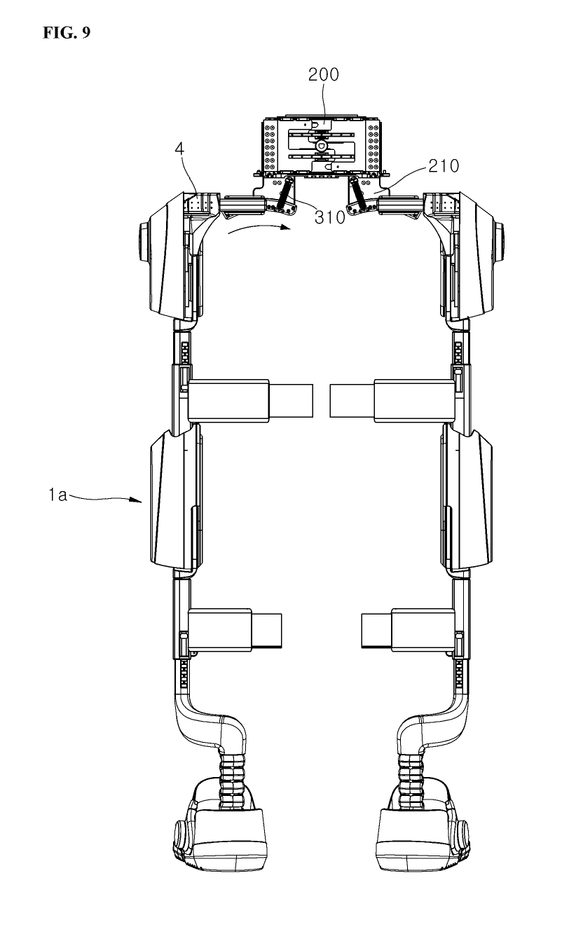

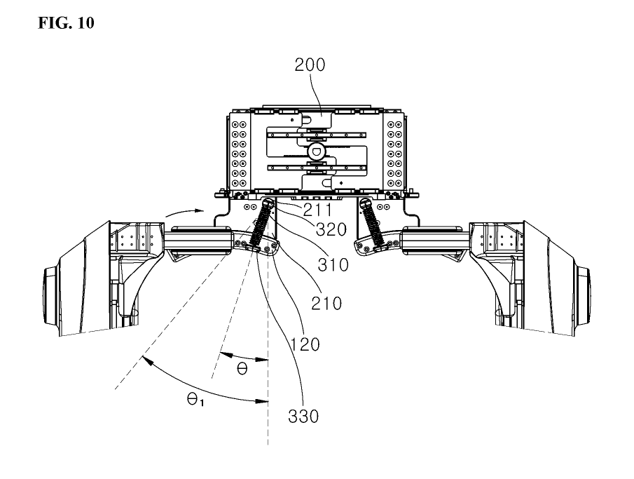

FIGS. 7 and 8 show an operation in which a pair of actuated limbs is opened or pivoted inward and outward (i.e. leftward and rightward) in a frontal plane of motion. FIG. 9 and FIG. 10 show a state where the actuated limbs are returned to a resting position via the posture restoring assembly.

Referring to FIGS. 7 and 8, the movable member 120 installed on the main frame 4 of the actuated limb 1a may be moved along the movement path of the rail member 110. As previously described, the spring 310 may be elastically stretched as the movable member 120 moves, creating an elastic force or restoring force. The spring 310 may have an upper end connected to a connector of the main body 200, while a lower end of the spring 310 may be fixed to and gradually moved with a rotation and movement of the movable member 120.

Accordingly, the spring 310 may be opened or rotated outward at the upper end to form an angle 81 greater than the angle θ at which the spring 310 is extended in the initial posture. The angle 81 may also be an acute angle. In addition, when the position of the lower end of the spring 310 is moved with the movable member 120, the spring 310 may be stretched to have a predetermined restoring force. In this state, when a rotational force applied to the rotated or pivoted actuated limb 1a is released, the actuated limb 1a may pivot to return to the initial position by the restoring force of the spring 310.

The case where an applied force is released can be largely classified into two cases. First, the exoskeleton 1 may be supported on a separate supporter (not shown) and stored. A predetermined section of an exoskeleton 1 may be supported by the supporter. The pair of actuated limbs 1a may be spaced apart from the ground, so there may not be extra support from the ground. The springs 310 connecting the pair of actuated limbs 1a and the main body 200 may elastically rotate or pivot the pair of actuated limbs to the initial position via the restoring force. Accordingly, the pair of actuated limbs 1a can be stored on the supporter in a state where the actuated limbs 1a are parallel to each and vertical to the ground, even if the actuated limbs 1a are not in the initial position when the exoskeleton 1 is initially placed on top of the supporter.

Second, when the user wears the exoskeleton 1, his two legs, along with the actuated limbs 1a, may return to the initial position after the two legs are rotated leftward and rightward. As shown in FIG. 7, the actuated limb 1a may be rotated as the leg of the user is rotated. When a force (e.g., from the user or an assistant) rotating the actuated limb 1a is removed or released, the rotated actuated limb 1a may be automatically moved back to the initial position by the restoring force of the spring 310. In other words, the restoring force of the spring 310 may assist the user in returning his legs and the actuated limbs 1a to the initial position or resting state.

Therefore, when the user intends to rotate an actuated limb 1a from an initial position to a second position to assist a power of the leg, and then intends to return the actuated limb 1a to the initial position, the posture restoring assembly 300 may stably move the actuated limb 1a to the initial position thereof. Thus, as shown in FIGS. 9 and 10, the rotated actuated limb 1a can be elastically returned to the initial position thereof.

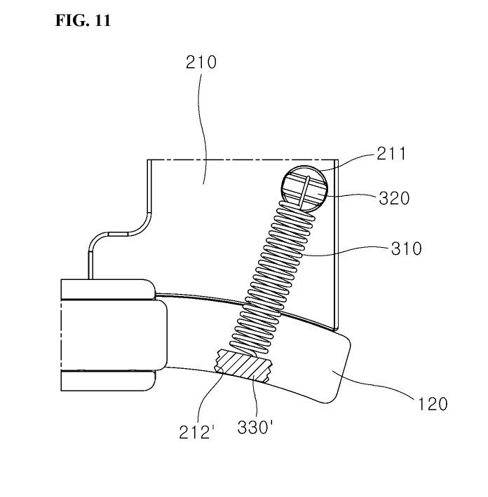

Referring to FIG. 11, a fixing member 330′ may be rotatably installed at a lower end of an elastic spring 310. A movable member 120 formed on a main frame 4 may be formed with a fixing groove or recess 212′ coupled to the fixing member 330′.

The fixing member 330′ and the fixing groove 212′ may be coupled to each other by a screw method. As an example, the fixing member 330′ may be a bolt or cylindrical pipe or bar with outer threads corresponding to inner threads of the fixing groove 212′, and the fixing member 330′ may screw into the fixing groove 212′. However, embodiments disclosed herein are not limited to such a coupling between the fixing member 330′ and the fixing groove 212′. An upper end of the spring 310 may be connected to the connector 210 of the main body 200. As an example, the upper end of the spring 310 may be coupled to a rotation member 320 that rotates within a socket 211.

Upper and lower positions of the spring 310 may be adjusted based on how the upper and lower ends of the spring 310 are coupled and/or connected to the main body 200 and the main frame 4, respectively. As an example, positions of the socket 211 and the fixing groove 212′ may be varied. In addition, a degree in which the spring 310 is compressed, stretched, or relaxed may be adjusted depending on a position or length of the fixing member 330′ and/or a position or depth of the fixing groove 212′. As an example, the spring may be further expanded if the fixing member 330′ is screwed further downward into the fixing groove 212′. The restoring force of the spring 310 may be predetermined or preset, and may be adjusted via the fixing member 330′ and the fixing groove 212′ during long periods of use.

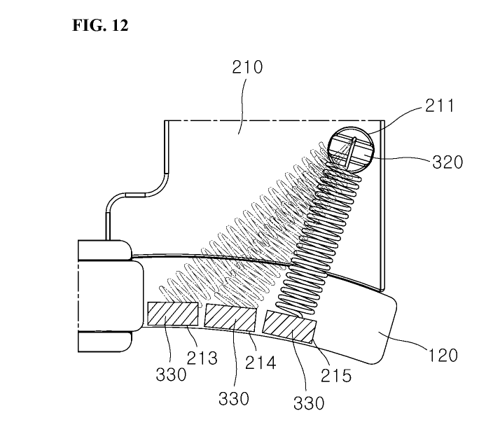

Referring to FIG. 12, a fixing groove 212 may be formed in a movable member 120. There may be a plurality of fixing grooves 212 in which the fixing member 330 may be placed. As an alternative, there may be one fixing groove 212 that extends across the movable member 120 such that the fixing member 330 may be slid across the fixing groove 212 to adjust a position of the lower end of the spring 310. For convenience of description, an example where there is a plurality of fixing grooves 212 will be described.

The plurality of fixing grooves 212 may be formed in the movable member 120. As an example, there may be a first fixing groove 213, a second fixing groove 214, and a third fixing groove 215 in the plurality of fixing groove 212. The fixing grooves 213, 214, and 215 may be spaced apart from each other along a longitudinal direction of the movable member 120.

Each fixing groove 213, 214, and 215 may be configured so that a fixing member 330 provided at the lower end of the spring 310 is fitted and fixed thereto. As an example, the fixing member 330 may be screwed into one of the plurality of fixing grooves 212. Alternatively, the fixing member 330 may be pressed-fit or friction-fitted into one of the plurality of fixing grooves 212.

Therefore, the position at which the other end of the elastic spring 310 is fixed can be changed by changing which fixing groove 213, 214, or 215 the fixing member 330 is coupled to. Accordingly, by changing the position of the lower end of the spring 310, an restoring force that returns an actuated limb 1a to an initial position may be changed.

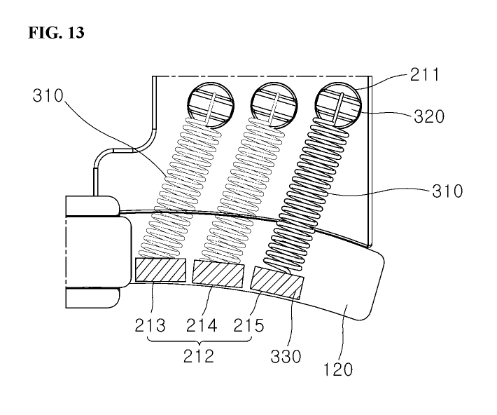

Referring to FIG. 13, a plurality of springs 310 may be provided. The plurality of springs 310 may coupled at a plurality of positions at the connector 210. As an example, the connector 210 may have a plurality of sockets 211. The plurality of sockets 211 may be spaced apart from each other by a first distance. A plurality of fixing grooves 212 may be formed in the movable member 120. The plurality of fixing grooves 212 may be spaced apart from each other by a second distance. Each of the plurality of springs 310 elastically connects the socket 211 and the fixing groove 212.

The plurality of sockets 211 may alternatively be referred to as first connection portions or first connecting positions. The plurality of fixing grooves may alternatively be referred to as second connection portions or second connecting positions.

By providing a plurality of springs 310, the actuated limb 1a may be returned to the initial position by means of a more stable restoring force. Further, even if any one of the springs 310 is broken, there may still be a restoring force. The restoring force may be prevented from being reduced to a certain magnitude or less by providing a plurality of springs 310.

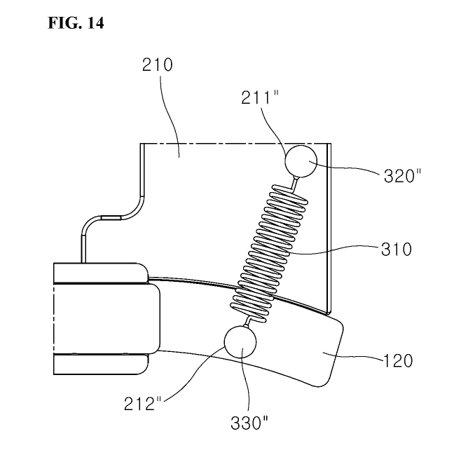

Referring to FIG. 14, according to an embodiment, a first fixing sphere or top sphere 320″ may be provided on an upper end of a spring 310. A second fixing sphere or bottom sphere 330″ may be provided on a lower end of the spring 310.

The top sphere 320″ may be fitted and fixed in a first guide hole or socket 211″ formed in a lower end of a connector 210. The first guide hole or socket 211″ may guide a rotation of the top sphere 320. The first socket 211″ may be a spherical cavity or recess in the connectors 210, or may be a hole.

The bottom sphere 330″ may be fitted and fixed in a second guide hole or socket 212″ formed in a moveable member 120 to guide a rotation of the bottom sphere 330″. The second socket 211″ may be a spherical cavity or recess in the moveable member 120, or may be a hole.

According to an embodiment, a pair of actuated limbs 1a can be rotated leftward and rightward by the guide 100 (FIG. 5) described above. The spring 310 may elastically return the actuated limb 1a to an initial position thereof when the actuated limb 1a is rotated.

Due to a rotation of the actuated limb 1a, the ends of the spring 310 are may be stressed, damaged, or fatigued. Therefore, according to an embodiment, ends of the spring 310 may be rotated at connecting positions in the connector 210 or the moveable member 120. As an example, top socket 211 and bottom socket 212 may be provided at the connecting positions in the connector 210 and the moveable member 120, respectively. Alternatively, a socket 211 and fixing groove 212 may be provided at the connecting positions in the connector 210 and the moveable member 120, respectively.

When the spring 310 is rotated, the top sphere 320″ may be rotated by a swivel method while being connected to the first socket 211″. Further, the bottom sphere 330″ may be rotated by a swivel method while being connected to the second socket 212″.

As described above, as both ends of the spring 310 are rotatably connected by a swivel method at the connection positions, breakage or damage may be effectively prevented. Furthermore, misuse may be prevented when the actuated limb 1a is returned to the initial position.

Embodiments disclosed herein may provide a posture restoring unit or assembly for a wearable assistive device such as a wearable robot, and more specifically an exoskeleton. The posture restoring assembly may restore a pair of actuated limbs to an initial posture while the exoskeleon is supported.

The posture restoring assembly may be capable of stably guiding a posture of the user's leg to an initial position thereof by using an elastic force or restoring force when the user changes a posture of a leg while wearing the exoskeleton.

Embodiments disclosed herein may provide a posture restoring unit or assembly for a power assisting robot or exoskeleton that may connect both sides of a main control unit or main controller and upper ends of a pair of leg assemblies or actuated limbs via the posture restoring assembly having an elastic or restoring force to return the pair of leg assemblies to an initial position thereof. The posture restoring assembly may connect the pair of leg assemblies to the main controller via the elastic force and elastically return the pair of leg assemblies when the posture of the leg is continuously changed.

A wire guide unit or wire guide may movably support wires connected to the respective drives, actuators, or motors in the main controller so that the lengths of the wires can be kept constant when the width of the waist is adjusted, allowing the wires to be pulled over a certain level of force to prevent a disconnection. In addition, the wire guide may support the wires connected to the respective drives so as to be spaced apart from each other in the main controller so that the wires do not contact each other while the wires are moved. As a result, it is possible to prevent an electrical short from occurring due to physical contact, even if a wire is damaged.

Various substitutions, modifications and changes can be made within the scope that does not deviate from the technical idea of the present disclosure for those skilled in the art to which the present disclosure pertains, the above-mentioned disclosure is not limited to the above-mentioned embodiment and the accompanying drawings.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the fixgures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A wearable assistive device, comprising:
a lumbar/back frame;
at least one first actuated limb slideably coupled to a first side of the lumbar/back frame;
a posture restoring assembly that connects a first side of the lumbar/back frame and an upper end of the first actuated limb, the posture restoring assembly having a spring to restore the first actuated limb to a resting position by using a restoring force.

2. The wearable assistive device of claim 1, wherein the first side of the lumbar/back frame and the upper end of the first actuated limb are connected via a guide, the guide comprising:
a rail member coupled to a lower end of the first side of the lumbar/back frame to form a movement path, and
a movable member coupled to the upper end of the first actuated limb to be moveable along the movement path formed by the rail member.

3. The wearable assistive device of claim 1, further including a second actuated limb rotatably arranged at a second side of the lumbar/back frame, wherein the posture restoring assembly connects the second side of the lumbar/back frame and an upper end of the second actuated limb and restores the second actuated limb to the resting position by using the restoring force.

4. The wearable assistive device of claim 2, wherein the spring generates a predetermined restoring force, and has an upper end connected to the first side of the lumbar/back frame and a lower end connected to the movable member.

5. The wearable assistive device of claim 4, wherein a fixing member is coupled to the lower end of the spring, a fixing groove is formed at a predetermined position in the movable member, and the fixing member is detachably coupled to the fixing groove.

6. The wearable assistive device of claim 5, wherein the fixing member is coupled to the fixing groove by a screw method.

7. The wearable assistive device of claim 5, wherein a plurality of fixing grooves are formed to be spaced apart from each other along a longitudinal direction of the movable member.

8. The wearable assistive device of claim 4, wherein a plurality of springs are provided.

9. The wearable assistive device of claim 4, wherein a first rotation member is coupled to an upper end of the spring and a second rotation member is coupled to a lower end of the spring, and wherein the first rotation member is fitted in a first socket formed on the first side of the lumbar/back frame and the second rotation member is fitted into a second socket formed in the movable member.

10. The wearable assistive device of claim 9, wherein the first and second rotation members are spheres configured to rotate within the first and second sockets, respectively.

11. The wearable assistive device of claim 9, wherein the first socket is configured to guide a rotation of the first rotation member, and the second socket is configured to guide a rotation of the second rotation member.

12. The wearable assistive device of claim 4, wherein the lumbar/back frame includes:
a main body, and
a connector protruding from the lower end of the main body, wherein the rail member is installed at a lower end of the connector and forms the movement path through an upward convex curvature, and the upper end of the spring is connected to an upper end of the connector.

13. The wearable assistive device of claim 4, wherein, when the spring is at the resting position, an angle between the spring and a longitudinal axis parallel to the first actuated limb is acute.

14. A posture restoring assembly configured to restore a wearable assistive device to a resting posture, including:
a plate;
a frame configured to move along the plate; and
an elastic member coupled to the plate and the frame.

15. The posture restoring assembly of claim 14, wherein the elastic member is a spring having an upper end fixed to the plate and a lower end fixed to the frame, the upper end being configured to pivot relative to the plate.

16. The posture restoring assembly of claim 15, wherein the upper end of the spring fits into an opening of the plate to rotate, the lower end of the spring detachably couples to a recess out of a plurality of recesses on the frame, and a resting position of the frame on the plate may be adjusted based on which recess the lower of the spring is detachably coupled to.

17. The posture restoring assembly of claim 14, wherein, when the frame is moved via an external force from a resting position on the plate, the elastic member stretches.

18. The posture restoring assembly of claim 17, wherein, when the external force applied to the frame is released, a restoring force of the elastic member moves the frame back to the resting position on the plate.

19. The posture restoring assembly of claim 14, wherein the frame is slideably coupled to a rail member that is coupled to the plate such that the frame moves along a curved path of the rail member.

20. The posture restoring assembly of claim 14, wherein the frame is coupled to an actuated limb of a wearable assistive device that is secured to a limb of the user, and
when the user applies a force to move the actuated limb away from a resting position, a restoring force of the elastic member moves the actuated limb back to the resting position when the external force is released.
